(19) United States
(12) Patent Application Publication
(10) Pub. No.: US 2014/0226867 A1
(43) Pub. Date: Aug. 14, 2014

(54) SYSTEMS, DEVICES, AND METHODS FOR MONITORING AND CONTROLLING A CONTROLLED SPACE

(71) Applicants: Chenguang Liu, Logan, UT (US); Ran Chang, Logan, UT (US); Bruce Christensen, Derby, KS (US); Juan De La Cruz, San Geronimo (DO); Pranab Banerjee, Burlington, MA (US); Doug Ahlstrom, Austin, TX (US); Aravind Dasu, Herndon, VA (US)

(72) Inventors: Chenguang Liu, Logan, UT (US); Ran Chang, Logan, UT (US); Bruce Christensen, Derby, KS (US); Juan De La Cruz, San Geronimo (DO); Pranab Banerjee, Burlington, MA (US); Doug Ahlstrom, Austin, TX (US); Aravind Dasu, Herndon, VA (US)

(73) Assignee: UTAH STATE UNIVERSITY, North Logan, UT (US)

(21) Appl. No.: 14/233,935

(22) PCT Filed: Jul. 19, 2012
(86) PCT No.: PCT/US2012/047458

§ 371 Date: Apr. 25, 2014

Related U.S. Application Data
(60) Provisional application No. 61/509,565, filed on Jul. 19, 2011.

(51) Int. Cl. G06T 7/20

(52) U.S. Cl. CPC G06T 7/2053; G06T 2207/10016; G06T 2207/20224
USPC 382/107

(57) ABSTRACT

A computer-implemented method for monitoring and controlling a controlled space. The method includes partitioning a controlled space into one or more regions; evaluating motion within the controlled space; determining occupancy within the one or more regions. The method may also include adjusting conditions within the controlled space based on whether the controlled space, or a specific region thereof, is occupied. Corresponding devices and systems are also disclosed herein.

### RELATED APPLICATIONS

This application claims priority to U.S. Provisional Application No. 61/509,565, entitled “APPARATUS AND METHOD FOR ILLUMINATION DIMMING”, filed on 19 Jul. 2011 for Chenguang Liu et al., the entirety of which is herein incorporated by reference. This application is also related in subject matter to PCT Application No. PCT/US12/41673, entitled “SYSTEMS AND METHODS FOR SENSING OCCUPANCY”, filed on Jun. 8, 2012 for Aravind Dasu et al., the entirety of which is herein incorporated by reference.

### STATEMENT REGARDING FEDERALLY SPONSORED RESEARCH/DEVELOPMENT

This invention was made with government support under Grant Number EE0003114 awarded by the U.S. Department of Energy. The government has certain rights in the invention.

### BACKGROUND

The use of sensors to control various electronic devices or systems in rooms has been explored. However, improved methods, systems, and apparatuses are needed to increase for improved efficiencies, convenience, and wide-spread implementation in living and workspaces. Various methods for sensing occupancy in a room have been explored.

### SUMMARY

The present disclosure in aspects and embodiments addresses these various needs and problems by providing a computer implemented method for monitoring and controlling a controlled space. In embodiments, the method may include partitioning a controlled space into one or more regions; evaluating motion within the controlled space; determining occupancy within the one or more regions. The method may also include adjusting conditions within the controlled space based on whether the controlled space, or a specific region thereof, is occupied. In some embodiments, results from successive evaluations of whether non-persistent motion has occurred may drive a state machine with a plurality of triggers such as a motion disappear trigger, workspace motion trigger, an outer border region trigger, an inner border region trigger, and a failsafe timeout trigger.

The methods disclosed herein may also include adjusting conditions within the controlled space based on whether the controlled space, or a specific region thereof, is occupied. Corresponding devices and systems are also disclosed herein.

In embodiments, the method may further comprise adjusting conditions within the controlled space based on whether non-persistent motion has occurred within the controlled space.

In embodiments of methods, adjusting conditions may be selected from the group consisting of adjusting general lighting, adjusting task lighting, adjusting heating, adjusting ventilation, and adjusting cooling.

In embodiments of methods, determining occupancy may comprise driving a state machine with a plurality of triggers corresponding to whether non-persistent motion has occurred within the controlled space.

In embodiments of methods, a trigger of the plurality of triggers may be selected from the group consisting of a motion disappear trigger, a workspace motion trigger, an outer border region trigger, an inner border region trigger, and a failsafe timeout trigger.

In embodiments of methods, the state machine may comprise one or more occupied states and one or more transition states.

In embodiments of methods, the transition states may comprise a first transition state corresponding to the outer border trigger and a second transition state corresponding to the inner border trigger.

In some embodiments of methods, adjusting conditions may comprise adjusting task specific lighting corresponding to an interior region within the controlled space.

In embodiments of methods, evaluating may comprise creating a difference image from two sequential images; creating a corrected difference image from the difference image; creating a persistence image from the corrected difference image; and creating a history image from the persistence image.

In embodiments of methods, creating a persistence image may comprise incrementing a persistence count if motion has occurred and decrementing the persistence count if motion has not occurred.

In other embodiments, an system for monitoring and controlling a controlled space may comprise a sensor interface module configured to collect a sequence of images for a controlled space; a partitioning module configured to partition out of the controlled space an inner border region, an outer border region, and one or more interior regions; a motion evaluation module configured to evaluate from the sequence of images whether non-persistent motion has occurred within the inner border region, the outer border region and the one or more interior regions; and an occupant determination module configured to use successive evaluations of whether non-persistent motion has occurred within the inner border region, the outer border region and the one or more interior regions to determine whether the controlled space is occupied.

In embodiments of systems, the occupant determination module may comprise a state machine and a state machine update module configured to drive the state machine with a plurality of triggers corresponding to whether non-persistent motion has occurred within specific regions of the controlled space.

In embodiments of systems, a trigger of the plurality of triggers may be selected from the group consisting of a motion disappear trigger, a workspace motion trigger, an outer border region trigger, an inner border region trigger, and a failsafe timeout trigger.

In embodiments of systems, the state machine may comprise one or more occupied states and one or more transition states.

In embodiments of systems, the transition states may comprise a first transition state corresponding to the outer border trigger and a second transition state corresponding to the inner border trigger.

In some embodiments, the system may further comprise a conditions control module for adjusting conditions within the controlled space based on an evaluation of whether non-persistent motion has occurred within the controlled space.

In embodiments of systems, the conditions control module may be configured to make an adjustment selected from the group consisting of a general lighting adjustment, a task lighting adjustment, a heating adjustment, a ventilation adjustment, and a cooling adjustment.

In some embodiments of systems, the motion evaluation module may comprise a motion detection module configured to perform a comparison of a past and a current image and create a difference image; a noise reduction module configured to create a corrected difference image from the difference image; a motion persistence module configured to create a persistence image from the corrected difference image; and a motion history module configured to create a motion history image from the persistence image.

In embodiments of systems, the motion persistence module may be further configured to increment a persistence count if motion has occurred and decrement the persistence count if motion has not occurred.

In other embodiments, a system for monitoring and controlling a controlled space, the system may comprise a sensor configured to provide a sequence of images for a controlled space; a controller configured to: receive the sequence of images for the controlled space; partition out of the controlled space an inner border region, an outer border region, and one or more interior regions; evaluate from the sequence of images whether non-persistent motion has occurred within the inner border region, the outer border region, and the interior regions over the sequence of images; use successive evaluations of whether non-persistent motion has occurred within the inner border region, the outer border region and the one or more interior regions to determine whether the controlled space is occupied; and a controllable device selected from the group consisting of a lighting device, a heating device, a cooling device, and a ventilation device.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIGS. 1, 2, and 3 are block diagrams illustrating various embodiments of an environment in which the present system, devices, and methods may be deployed.

FIG. 4 is a block diagram illustrating an example controller in accordance with the present disclosure.

FIG. 5 is a schematic diagram of a digital image having a plurality of pixels.

FIG. 6 is a schematic diagram of an example difference image using the digital image of FIG. 5.

FIG. 7 is a schematic diagram of a corrected difference image.

FIG. 8 is a schematic diagram of an example persistence image based on the corrected difference image of FIG. 7.

FIG. 9 is a schematic diagram of an example motion history image based on the corrected difference image of FIG. 8.

FIG. 10 is a block diagram illustrating an example room from the environment of FIG. 1.

FIG. 11 is a block diagram showing a relationship of state machine triggers related to occupancy.

FIG. 12 is a flow diagram illustrating a portion of one example method of determining occupancy of a room.

FIG. 13 is a flow diagram illustrating another portion of the example method of FIGS. 11 and 12.

FIG. 14 is a flow diagram illustrating another portion of the example method of FIGS. 11-13.

FIG. 15 is a flow diagram illustrating another portion of the example method of FIGS. 11-14.

FIG. 16 is a flow diagram illustrating another portion of the example method of FIGS. 11-15.

FIG. 17 is a flow diagram illustrating another portion of the example method of FIGS. 11-16.

FIG. 18 depicts a block diagram of an electronic device suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

Building efficiency and energy conservation is becoming increasingly important in our society. One way to conserve energy is to power devices in a controlled space only when those devices are needed. Many types of devices are needed only when the user is within a controlled space or in close proximity to such devices. One scenario is an office that includes a plurality of electronic devices such as lighting, heating and air conditioning, computers, telephones, etc. One aspect of the present disclosure relates to monitoring the presence of one or more occupants within a controlled space, and turning on and off at least some of the electronic devices based on the user's proximity to, or location within, the controlled space.

A controlled space monitoring and controlling system and related devices and methods may be used to determine whether an occupant is present within a given controlled space. A sequence of images of the controlled space may be used to determine the occupant's location. The sequence allows motion data to be extracted from the images. The current and past motion from the images comprises what may be referred to as motion history. Occupancy information including the location of an occupant may be used, for example, so that lighting within the space may be adjusted to maximally reduce energy consumption. Another example is altering room heating or cooling or providing other environmental controls in response to determining the occupant's location.

### I. Controlled Space and Regions

In embodiments described herein, the space to monitor and sense occupancy is typically referred to as a controlled space, which may or may not have physical boundaries. For example, the controlled space may have one or more fixed walls with specific entrance locations or may be a region within a building that warrants monitoring and control separate from other portions of the building. Proper placement and size of borders and regions help provide the best operation of the occupancy sensor by allowing the method embodiments of the present disclosure to accurately predict when an occupant has entered or left the controlled space or regions within the controlled space. The borders and regions occupy enough pixels in the image such that the method can detect an occupant's presence within them.

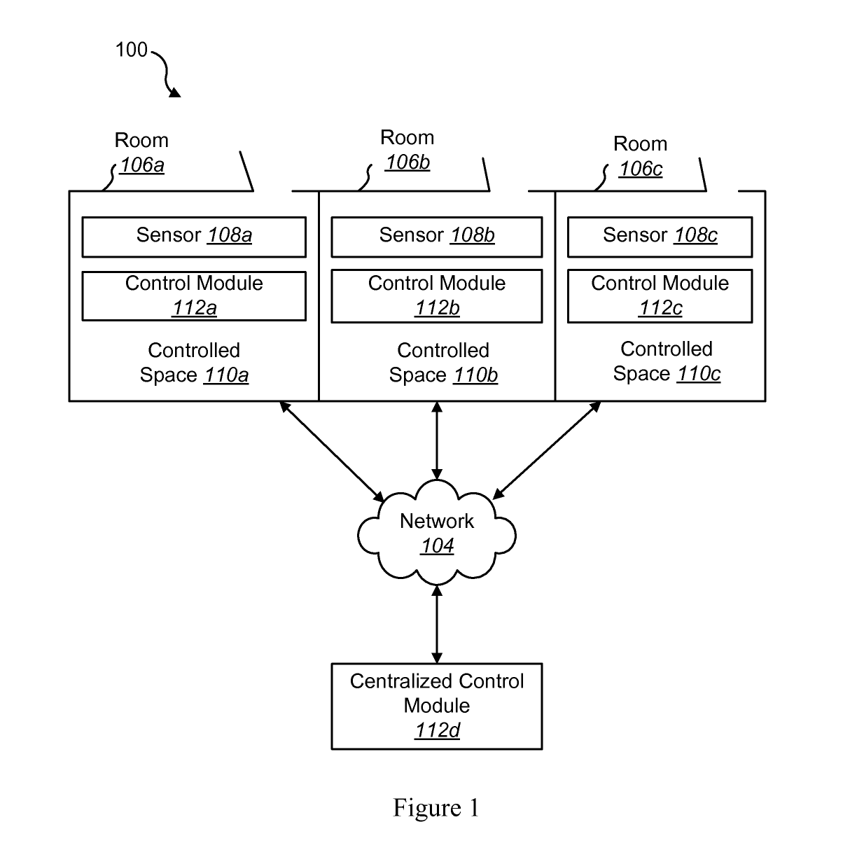

FIGS. 1, 2, 3, and 10 depict several example environments 100 in which the disclosed embodiments may be deployed. As depicted, the example environments 100 may include a network 104, one or more image sensors 108 which provide images of one or more controlled spaces 110 to one or more control modules 112 (112a-d). The control modules 112 may be localized (112a-c), centralized (112d), or distributed (112a-c). The control modules 112 may be interconnected by the network 104 (as shown in FIG. 1) or they may operate in isolation from other control modules 112.

The image sensors 108 provide images of the controlled spaces 110 where each pixel represents a measured value corresponding to a particular location (i.e. sampled area) within each controlled space. The measured values may correspond to luminosity or intensity over a particular region of the visible or non-visible spectrum. For example, an image sensor 108 may be a camera that with a CCD chip that is sensitive to visible or infrared light.

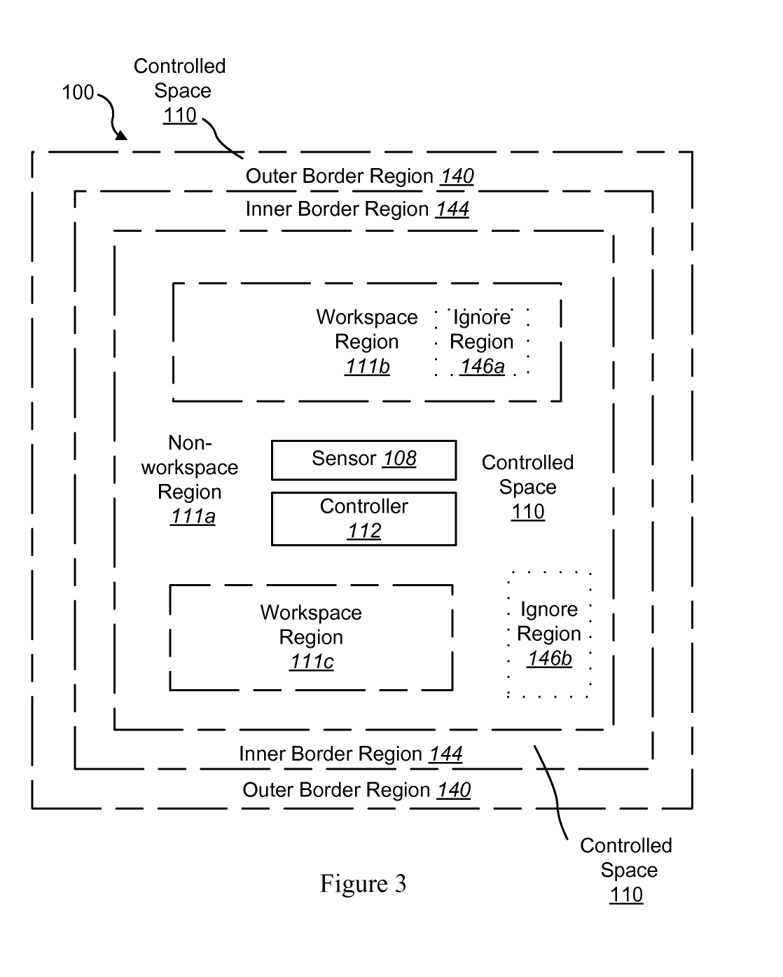

The controlled space 110 may be partitioned or bounded by one or more rooms 106. Alternately, as shown in FIG. 3, the controlled space may be an area or region that is separately monitored and controlled within a larger space such as a warehouse or factory. The controlled space 110 may also be partitioned into regions to facilitate improved occupancy detection and better control of conditions within particular regions within the controlled space 110.

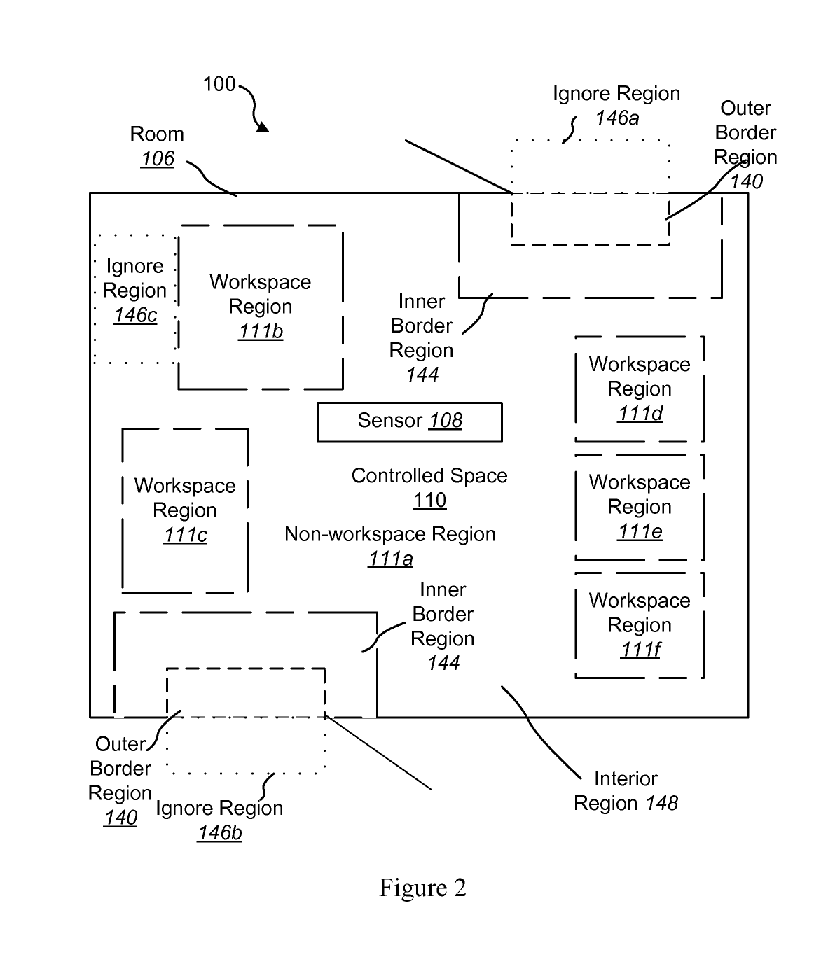

For example, FIG. 2 depicts a controlled space 110 corresponding to a room 106 that includes a non-workspace region 111a, various workspace regions 111b-111f, a pair of outer border regions 140 and inner border regions 144 that correspond to entries to the room 106, as well as several ignore regions 146a-c. Note that the ignore region 146a is immediately outside of the room 106 and may optionally be considered part of the controlled space 110. In contrast, yet conceptually similar, FIG. 3 depicts a controlled space 110 with no bounding walls that includes a non-workspace region 111a, a pair of workspace regions 111b and 111c, an outer border region 140 and an inner border region 144 that encompass the controlled space 110, and a pair of ignore regions 146a and 146b located within the controlled space.

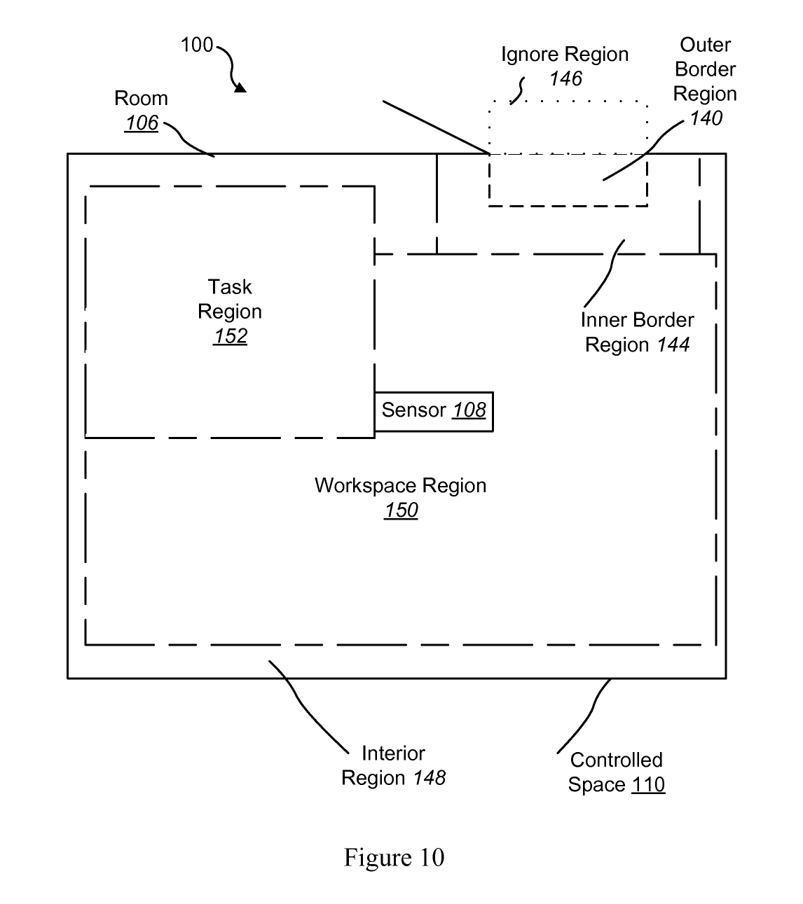

FIG. 10, referred to more detail below, depicts other regions within the controlled space 110, including a Workspace Region 150 and a Task Region 152.

### II. Control Module Overview

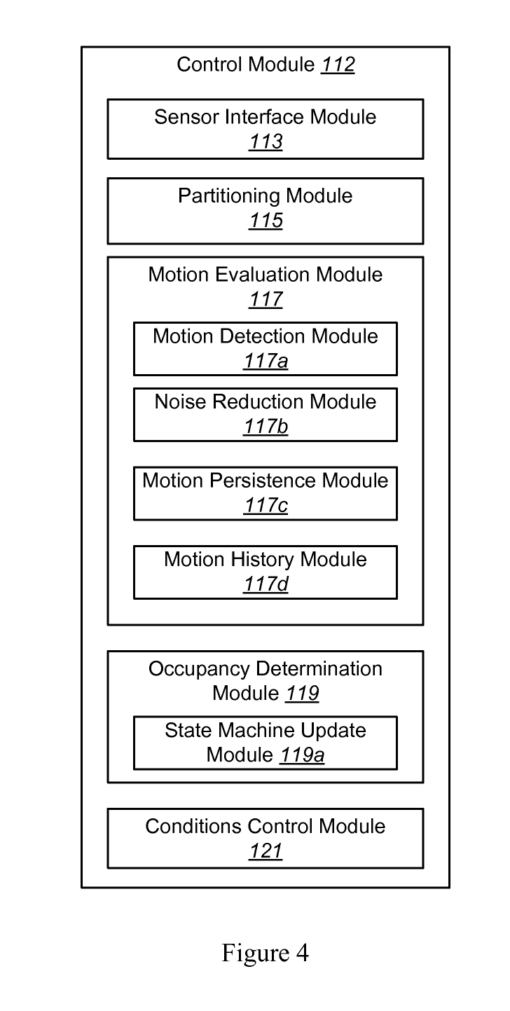

Referring to FIG. 4, a control module 112 may include a plurality of sub-modules that perform various functions related to the disclosed systems, devices, and methods. As depicted, the controller 112 includes a sensor interface module 113, a partitioning module 115, a motion evaluation module 117, an occupant detection module 119 and a conditions control module 121.

The sensor interface module 113 may collect a sequence of images for a controlled space 110 that are provided by an image sensor 108 or the like. The images may be composed of pixels that correspond to reflected or emitted light at specific locations within the controlled space. The reflected or emitted light may be visible or infrared.

The partitioning module 115 may partition the controlled space into a plurality of regions, shown in FIGS. 1-3 and 10, either automatically or under user or administrator control. The plurality of regions may facilitate detecting individuals entering or exiting the controlled space or specific areas or regions within the controlled space.

The motion evaluation module 117 may determine from the sequence of images whether non-persistent motion has occurred within the various regions over a time interval and thereby enable the occupant detection module 119 to determine whether the controlled space and specific regions therein are occupied.

The occupant determination module 119 may comprise a state machine (not shown) and a state machine update module that drives the state machine with a plurality of triggers that indicate whether non-persistent motion has occurred within specific regions within the controlled space.

The conditions control module 121 may control any electrical device. Exemplary control modules 121 may control lighting, heating, air conditioning, or ventilation within the controlled space 110 or regions thereof. For example, when an occupant enters the general workspace area, the conditions control module 121 may signal for the overhead lighting to turn on. Similarly, when an occupant enters the task region 152, the amount of lighting may be adjusted according to the amount of other light already present in the task region. Likewise, when an occupant leaves the task area but remains in the workspace region 150, the overhead lighting may be turned on fully and the task lighting may be reduced or turned off. Also, when an occupant leaves the general workspace area, all the lighting may be turned off and the heating or air conditioning adjusted to save energy by not conditioning the unoccupied room. In embodiments, adjusting a condition includes, for example, turning on or off, increasing or decreasing power, diming or brightening, increasing or decreasing the temperature, actuating electrical motors or components, open or close window coverings, open or close vents, or otherwise controlling an electrical component or system.

Various of the above modules are described in more detail in the section below.

### III. Motion Evaluation

Referring again to FIG. 4, the motion evaluation module 117 may leverage a number of sub-modules. In the depicted embodiment, the sub-modules include a motion detection module 117a, a noise reduction module 117b, a motion persistence module 117c, and a motion history module 117d. Various configurations may be possible for controller 112 that include more or fewer modules or sub-modules than those shown in FIG. 4.

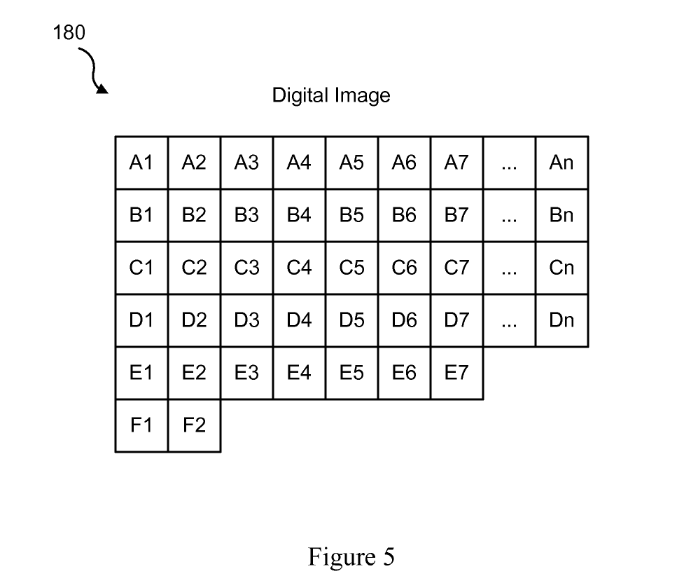

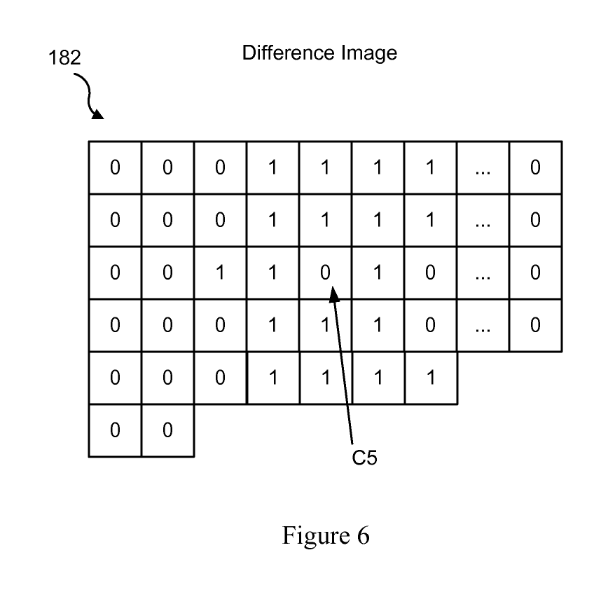

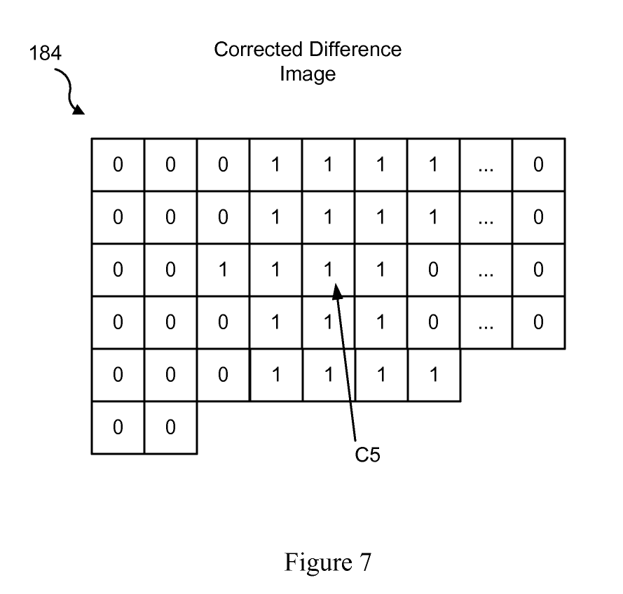

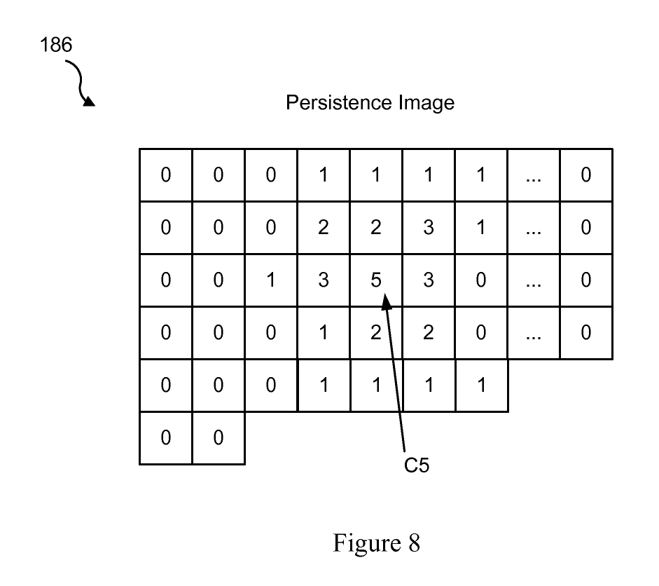

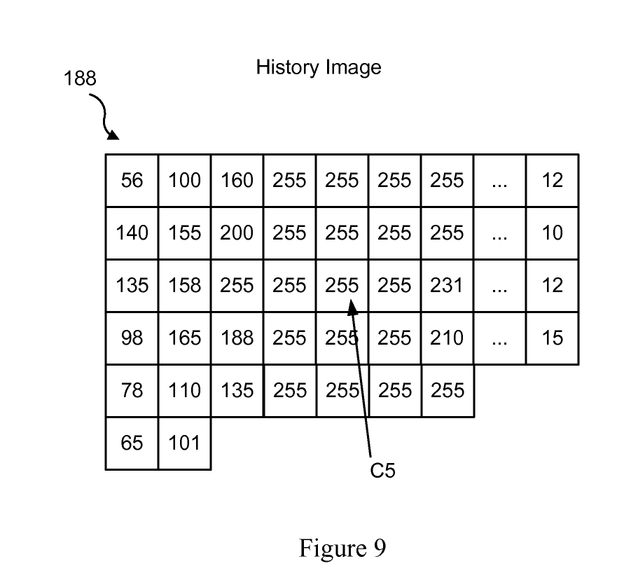

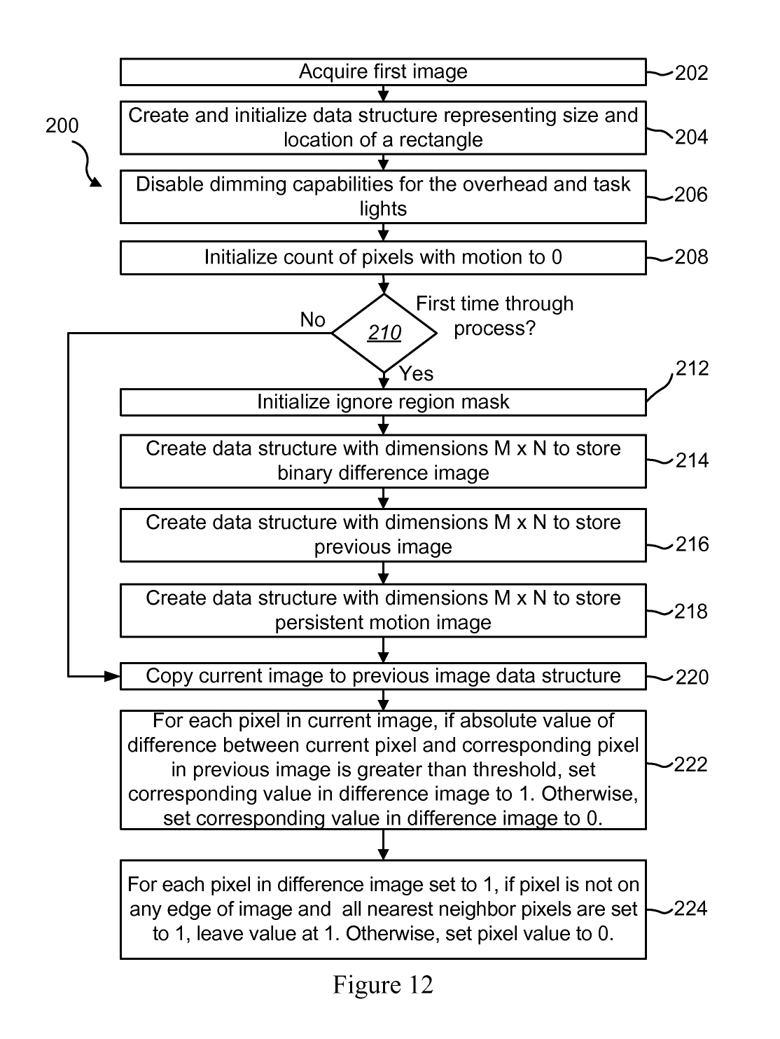

The motion detection module 117a may perform a comparison of past and current images and create the differencing image as described below with reference to FIG. 6. The noise reduction module 117b may create updates or corrections to the differencing image as described below with reference to FIG. 7. The motion persistence module 117c may help identify persistent movement that can be ignored and create a persistence image as described below with reference to FIG. 8. The motion history module 117d may create a history of detected motion and a motion history image as described below with reference to FIG. 9. The motion evaluation module 117, the occupancy determination module 119, and the state machine update module 119a may use the motion information described below with reference to FIGS. 5-11, and the method of FIGS. 12-17, to determine occupancy of a room and to control the conditions therein.

A. Motion Detection

1. Digital Image

Referring now to FIG. 5, a schematic digital image 180 is shown having a plurality of pixels labeled A1-An, B1-Bn, C1-Cn, D1-Dn, E1-E7 and F1-F2. The image 180 may include hundreds or thousands of pixels within the image. The image may be provided by the image sensor 108. The image 180 may be delivered to the controller 112 for further processing.

2. Difference Image

Referring now to FIG. 6, an example difference image 182 is shown with a plurality of pixels that correspond to the pixels of the image 180 shown in FIG. 5. The difference image 182 represents the difference between two sequential images 180 that are collected by the image sensor 108. The two sequential images may be referred to as a previous or prior image and a current image. For each pixel in the difference image 182, the absolute value of the difference in luminance between the current image and the previous image is compared to a threshold value.

In some embodiments, if the difference in luminance is greater than the threshold value, the corresponding pixel in the difference image 182 is set to 1 or some other predefined value. If the difference is less than the threshold value, the corresponding pixel in the difference image is set to 0 or some other preset value. The color black may correspond to 0 and white may correspond to 1. The threshold value is selected to be an amount sufficient to ignore differences in luminance values that should be considered noise. The resulting difference image 182 contains a 1 (or white color) for all pixels that represent motion between the current image and the previous image and a 0 (or black color) for all pixels that represent no motion. The pixel C5 is identified in FIG. 6 for purposes of tracking through the example images described below with reference to FIGS. 7-9.

B. Noise Reduction to Correct Difference Image

FIG. 7 shows a corrected difference image 184 that represents a correction to the difference image 182 wherein pixels representing motion in the difference image that should be considered invalid are changed because they are isolated from other pixels in the image. Such pixels are sometimes referred to as snow and may be considered generally as “noise.” In one embodiment, each pixel in the difference image 182 that does not lie on the edge of the image and contains the value 1, retains the value of 1 if the immediate neighboring pixel (adjacent and diagonal) is also 1. Otherwise, the value is changed to 0. Likewise, each pixel with a value of 0 may be changed to a value of 1 if the eight immediate neighboring pixels are 1, as shown for the pixel C5 in FIG. 7.

C. Motion Persistence and Image Erosion

FIG. 8 schematically represents an example persistence image 186 that helps in determining which pixels in the corrected difference image 184 may represent persistent motion, which is motion that is typically considered a type of noise and can be ignored. Each time a pixel in the corrected difference image 184 (or the difference image 182 if the correction shown in FIG. 7 is not made) represents valid motion, the value of the corresponding pixel in the persistence image 186 is incremented by 1. In some embodiments, incremental increases beyond a predetermined maximum value are ignored.

Each time a pixel in the corrected difference image 184 does not represent valid motion, the value of the corresponding pixel in the persistence image 186 is decremented. In some embodiments, the persistence image is decremented by 1, but may not go below 0. If the value of a pixel in a persistence image 186 is above a predetermined threshold, that pixel is considered to represent persistent motion. Persistent motion is motion that reoccurs often enough that it should be ignored (e.g., a fan blowing in an office controlled space). In the example of FIG. 8, if the threshold value were 4, then the pixel C5 would have exceeded the threshold and the pixel C5 would represent persistent motion.

D. Motion History

FIG. 9 schematically shows an example motion history image 188 that is used to help determine the history of motion in the controlled space. In one embodiment, each time a pixel in the current image 180 represents valid, non-persistent motion (e.g., as determined using the corrected difference image 184 and the persistence image 186), the corresponding pixel in the motion history image 188 is set to a predetermined value such as, for example, 255. Each time a pixel in the current image 180 does not represent valid, non-persistent motion, the corresponding pixel in the motion history image 188 is decremented by some predetermined value (e.g., 1, 5, 20) or multiplied by some predetermined factor (e.g., 0.9, ⅞, 0.5). This decremented value or multiplied factor may be referred to as decay. The resulting value of each pixel in the motion history image 188 indicates how recently motion was detected in that pixel. The larger the value of a pixel in the motion history image 188, the more recent the motion occurred in that pixel.

FIG. 9 shows a value 255 in each of the pixels where valid, non-persistent motion has occurred as determined using the corrected difference image 184 and the persistence image 186 (assuming none of the values in persistence image 186 have exceeded the threshold value). The pixels that had been determined as having either invalid or non-persistent motion (a value of 0 in images 184, 186) have some value less than 255 in the motion history image 188.

### IV. Region Partitioning

Proper placement in sizing of the regions within a controlled space may help optimize operation of the monitoring and controlling systems devices and methods discussed herein. Proper placement and size of the borders may allow the system to more accurately decide when an occupant has entered and departed a controlled space. The borders may occupy enough pixels in the collected image such that the system may detect the occupant's presence within each of the regions.

Referring again to FIG. 10, a further step may be to evaluate the number of pixels that represent motion in particular regions in the image. Assuming the image 180 represents an entire footprint of the room 106, the region in the image may include outer border region 140, inner border region 144, workspace region 150, task region 152, and ignore regions 146. Outer border region 140 is shown in FIG. 10 having a rectangular shape and may be positioned at the door opening. Outer border region 140 may be placed inside the controlled space 110 and as near the doorway as possible without occupying any pixels that lie outside of the doorway within the ignore region 146. Typically, a side that is positioned adjacent to the door opening is at least as wide as the width of the door.

Inner border region 144 may be placed around at least a portion of the periphery of outer border region 140. Inner border region 144 may surround all peripheral surfaces of outer border region 140 that are otherwise exposed to the controlled space 110. Inner border region 144 may be large enough that the system can detect the occupant's presence in inner border region 144 separate and distinct from detecting the occupant's presence in outer border region 140.

The room 106 may include one or more ignore regions 146. In the event the sensor 108 is able to see through the entrance of the room 106 (e.g. through an open door) into a space beyond outer border region 140 or see a region is associated with the persistent movement of machinery or the like, movement within the one or more ignore regions 146 may be masked and ignored.

The ignore regions 146 may also be rectangular in shape (or any other suitable shape) and may be placed at any suitable location such as adjacent to the outer border region 140 and outside the door opening. The ignore regions 146 may be used to mask pixels in the image (e.g., image 180) that are outside of the controlled space 110 or associated with constant persistent motion or specified by a user or administrator, but that are visible in the image. Any motion within the ignore regions 146 may be ignored.

### V. Occupancy Determination

A state machine may be updated using triggers generated by evaluating the number of pixels that represent valid, non-persistent motion within each region shown in FIG. 10. Examples of triggers and their associated priority may include a motion disappear trigger, a workspace motion trigger, an outer border region trigger, an inner border region trigger, and a failsafe timeout trigger. The motion disappear, workspace, and failsafe timeout triggers may represent occupied (or unoccupied) states and the border region Triggers may represent transition states. Each enabled trigger is evaluated in order of decreasing priority. If, for example, the currently evaluated trigger is the workspace motion trigger, the workspace motion updates the state machine and all other enabled triggers are discarded. This particular priority may be implemented because workspace motion makes any other motion irrelevant.

In one embodiment, to update the state machine, the number of pixels that represent valid, non-persistent motion is calculated. A grouping of pixels that represent valid, non-persistent motion may be designated as a Motion Region Area. If there are no motion pixels in any region, the motion ended trigger is enabled. If there are more motion pixels in the workspace region than the outer border region and inner border region, the workspace motion trigger is enabled. If there are more motion pixels in the inner border region than some predetermined threshold, the inner border region trigger is enabled. If there are more motion pixels in the outer border region than the inner border region, and if there are more motion pixels in outer border region than the general workspace region, the outer border region motion is enabled. If no motion has been detected for some predetermine timeout period, the failsafe timeout trigger is enabled.

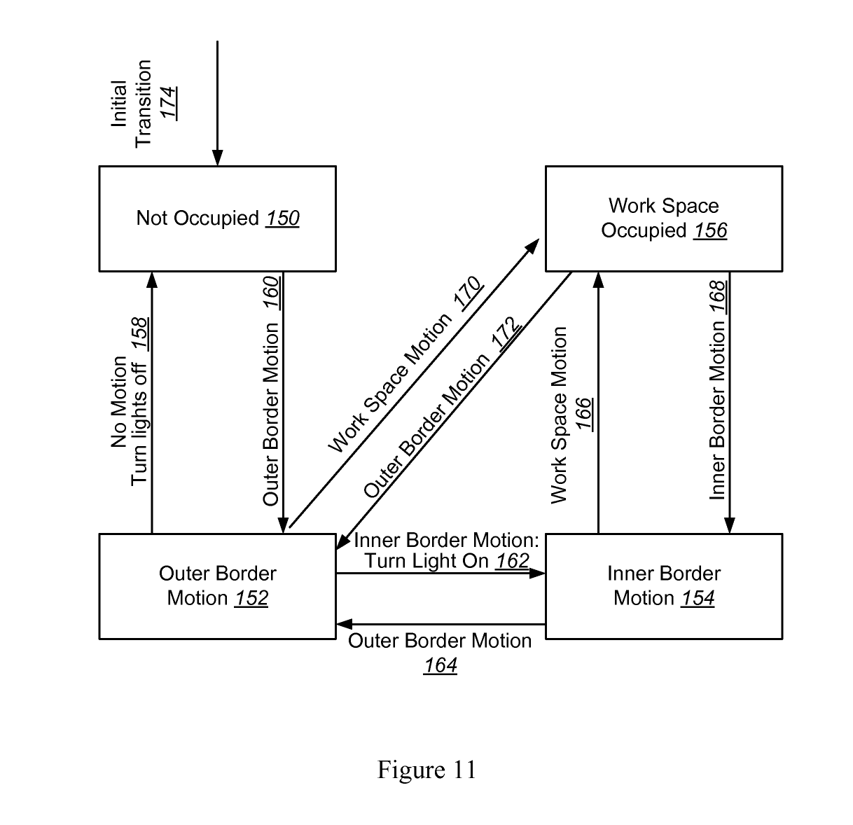

A state machine may be used to help define the behavior of the image sensor and related system and methods. As shown in FIG. 11, the state machine may include one or more occupied states and one or more transition states. In the depicted example, there are four states in the state machine: (1) not occupied, (2) outer border motion, (3) inner border motion, and (4) workspace occupied. Other examples may include more or fewer states depending on, for example, the number of borders established in the controlled space.

The not occupied state may be valid initially and when the occupant has moved from the outer border region to somewhere outside of the controlled space. If the occupant moves from the outer border region to somewhere outside of the controlled space, the controlled space environment may be altered (e.g., the lights turned off).

The outer border region motion state may be valid when the occupant has moved into the outer border region from either outside the controlled space or from within the interior space.

The inner border region motion state may be valid when the occupant has moved into the inner border region from either the outer border region or the interior space. If the occupant enters the inner border region from the outer border region, the controlled space environment may be altered (e.g., the lights turned on).

The workspace occupied state may be valid when the occupant has moved into the interior or non-border space from either the outer border region or the inner border region.

FIG. 11 schematically illustrates an example state machine having the four states described above. The state machine is typically set to not occupied 150 in response to an initial transition 174. The outer border region motion state 152, the inner border region motion state 154, and workspace occupied state 156 are interconnected with arrows that represent the movement of the occupant from one space or border to another.

A motion ended trigger may result, for example, in lights being turned off 158, and may occur as the occupant moves from outer border region 140 and into ignore region 146. An outer border region motion trigger 160 may occur as the occupant moves from outside of the controlled space 110 and into the outer border region 140. An inner border region motion trigger 162, resulting, for example, in turning a light on, may occur as the occupant moves from outer border region 140 to inner border region 144. An outer border region motion trigger 164 may occur as the occupant moves from the inner border region 144 to the outer border region 140. A workspace motion trigger 166 may occur as the occupant moves from inner border region 144 to the workspace 150. An inner border region motion trigger 168 may occur when an occupant moves from the workspace region 150 to the inner border region 144. A workspace motion trigger 170 may occur as the occupant moves from outer border region 140 to the workspace region 150. An outer border region motion trigger 172 may occur as the occupant moves from the workspace region 150 to the outer border region 140.

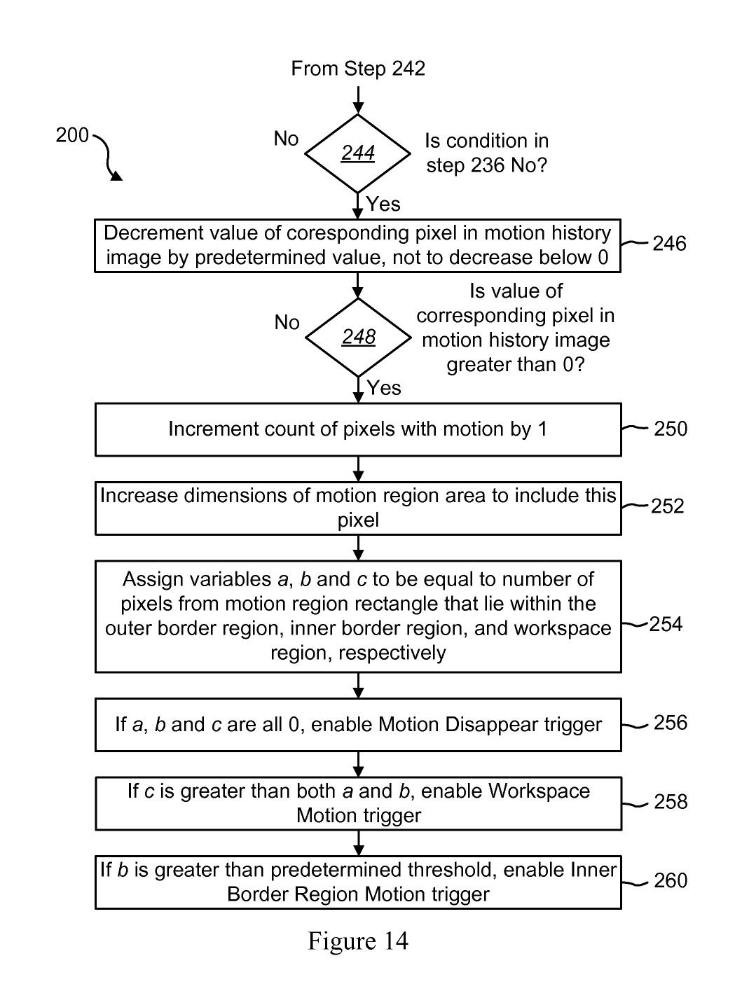

FIGS. 12-17 further illustrate a detailed method 200 for determining occupancy of a controlled space from a series of images and state machine logic. FIGS. 12-14 illustrate the beginning of the process which includes image acquisition and evaluation, as described above. The latter part of FIG. 14 and FIGS. 15-17 illustrate the completion of a process for determining occupancy through state machine logic and controlling the conditions within the controlled space. The sub-processes described herein may be combined with other processes for determining occupancy and controlling conditions in a controlled space.

FIG. 12 shows the method 200 beginning with acquiring a first image 202 M pixels wide by N pixels high and initializing the count of pixels with motion to 0 in the step 204. Step 206 disables the dimming capabilities for the overhead and task area lighting and step 208 initializes the count of pixels with motion to 0. A step 210 determines whether this is the first time through the method. If so, the method moves onto step 212 initializing an ignore region mask. If not, the system moves to step 220 and skips the steps of creating various data structures and the ignore mask region in steps 212-218.

Step 214 includes creating a data structure with dimensions M×N to store a binary difference image. Step 216 includes creating a data structure with dimensions M×N to store the previous image. Step 218 includes creating a data structure with dimensions M×N to store a persistent motion image. The following step 220 includes copying a current image to the previous image data structure. In step 222, for each pixel in the current image, if an absolute value of difference between the current pixel and corresponding pixel in a previous image is greater than a threshold, a corresponding value is set in a difference image to 1. Otherwise, a corresponding value is set in a difference image to 0. The step 224 includes leaving the value of a pixel at 1, for each pixel in the difference image set to 1, if the pixel is not on any edge of the image and all nearest neighbor pixels (e.g., the eight neighbor pixels) are set to 1. Otherwise, the pixel value is set at 0.

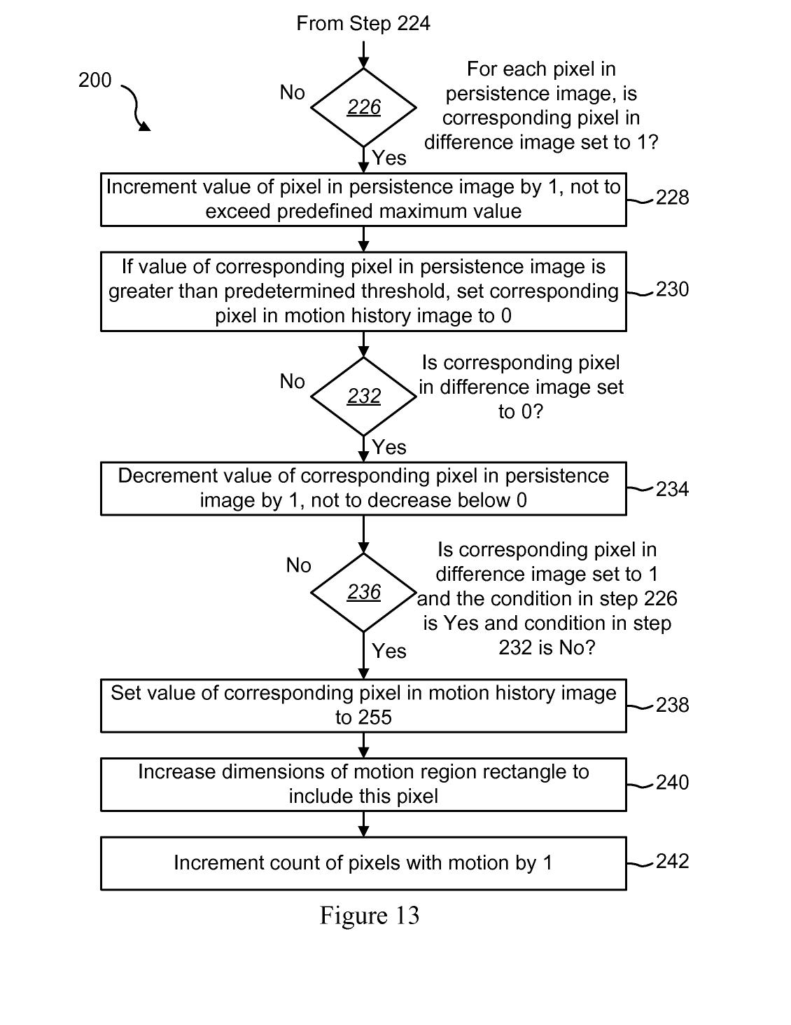

FIG. 13 shows further example steps of method 200. The method 200 may include determining for each pixel in the persistence image whether the corresponding pixel in the difference image is set to 1 in a step 226. Further step 228 includes incrementing the value of the pixel in the persistence image by 1, and not to exceed a predefined maximum value. If the value of the corresponding pixel and the persistence image is greater than a predetermined threshold, the corresponding pixel is set in the motion history image to 0 in a step 230.

A step 232 includes determining whether a corresponding pixel in a difference image is set to 0. If so, step 234 includes decrementing a value of the corresponding pixel in a persistence image by 1, and not to decrease below the value of 0. If a corresponding pixel in the difference image is set to 1 and the condition in step 226 is yes and the condition in step 232 is no, then a further step 238 includes setting a value of the corresponding pixel in a motion history image 255 or some other predefined value. A step 240 includes increasing the dimension of the motion region rectangle to include this pixel. An increment count of pixels with motion is increased by 1 in the step 242.

FIG. 14 shows potential additional steps of method 200 including step 244 of determining whether the condition in step 236 is no. If so, a step 246 includes decrementing a value of the corresponding pixel in the motion history image by a predetermined value, and not to decrease below a value of 0. If the value of the corresponding pixel in the motion history image is greater than 0, according to a step 248, a step 250 includes incrementing a count of pixels with motion by 1. A step 252 includes increasing a dimension of the motion region rectangle to include this pixel.

FIG. 14 further shows potential additional steps of the method 200 including a step 254 of assigning variables a, b and c to be equal to the number of pixels from a Motion Region Area that lie within outer border region 140, inner border region 144, and the workspace region 150, respectively. If a, b and c are all 0, a motion disappear trigger is enabled in step 256. If c is greater than both a and b, a workspace motion trigger is enabled in a step 254. If b is greater than a predetermined threshold, an inner border region motion trigger is enabled in a step 260.

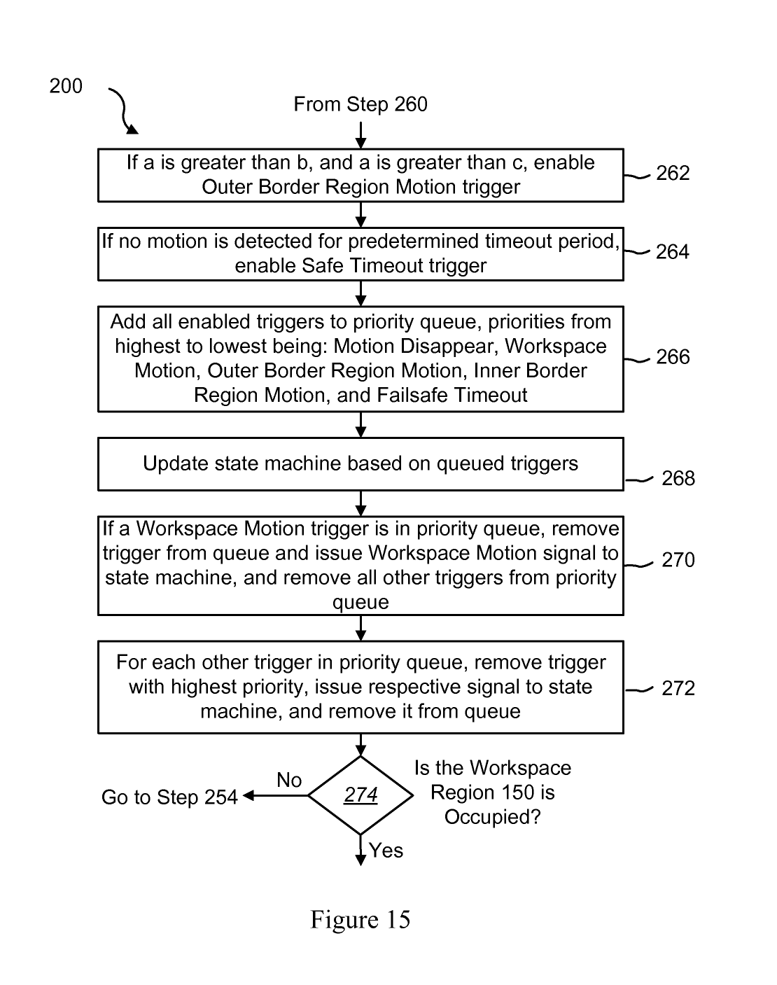

FIG. 15 illustrates additional steps of method 200. If a is greater than b, and a is greater than c, an outer border region motion is triggered in a step 262. If no motion is detected for a predetermined timeout period, a failsafe timeout trigger is enabled in a step 264. All enabled triggers may be added to a priority queue in a step 266. The priority may be arranged highest to lowest as according to a step 266: motion disappear, workspace motion, outer border region motion, inner border region motion, and the failsafe timeout.

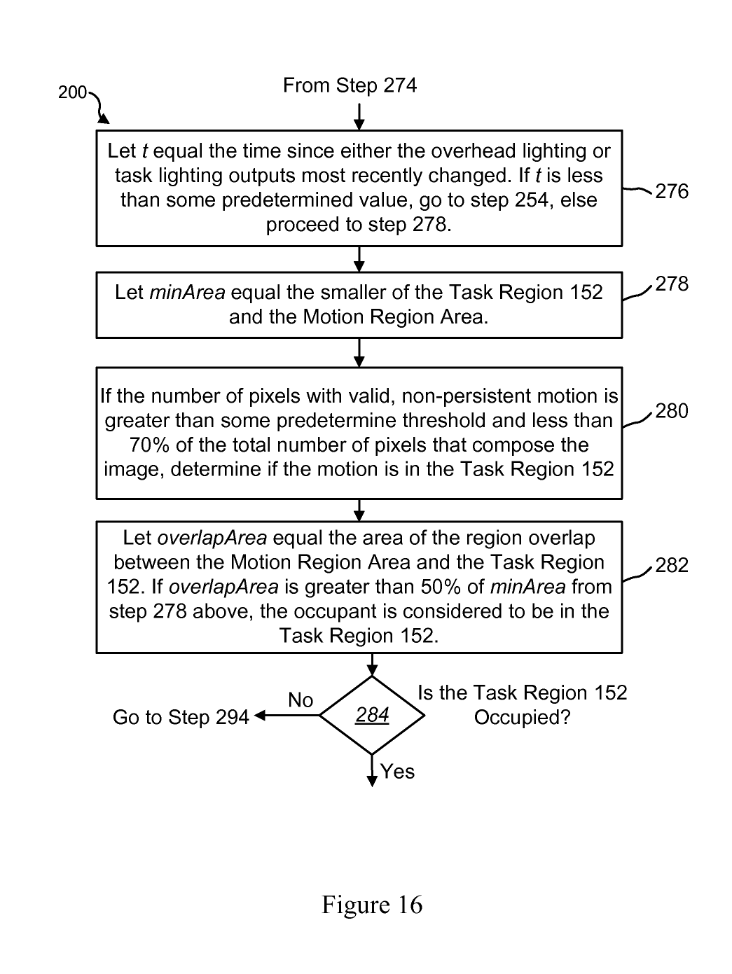

A step 268 includes updating a state machine based on the queue triggers. If a workspace motion trigger is in the priority queue, the trigger is removed from the queue and a workspace motion signal is issued to the state machine, according to a step 270. All of the other triggers may be removed from the priority queue. For each other trigger in the priority queue, a trigger with the highest priority is removed, a respective signal is issued to the state machine, and the trigger is removed from the queue according to a step 272. Further step 274 determines whether the Workspace Region 150 is occupied. If it is not, the process returns to step 254. If the Workspace Region 150 is occupied, the process continues to step 276, shown in FIG. 16.

FIG. 16 illustrates additional steps of method 200. In step 276, a variable t is assigned a value equaling the time since either the overhead lighting or task lighting outputs most recently changed. If t is less than some predetermined value, the process reverts to step 254, shown in FIG. 14. If t is greater than the predetermined value, the process may proceed to step 280.

In step 278, the variable minArea is assigned the value equal to the smaller of the Task Region 152 and the Motion Region Area. The Motion Region Area is a grouping of pixels that represent valid, non-persistent motion. Step 280 and 282 illustrate example steps of determining if the occupant is considered to be in the Task Region 152. If the number of pixels with valid, non-persistent motion is greater than some predetermine threshold, and less than, for example, 70% of the total number of pixels that compose the image, the process determines if the motion is in the Task Region 152. This may be done as illustrated in step 282 by assigning the variable overlapArea equal to the area of the region overlap between the Motion Region Area and the Task Region 152. In this example, if overlapArea is greater than 50% of MinArea from step 278, the occupant is considered to be in the Task Region 152.

### VI. Condition Control

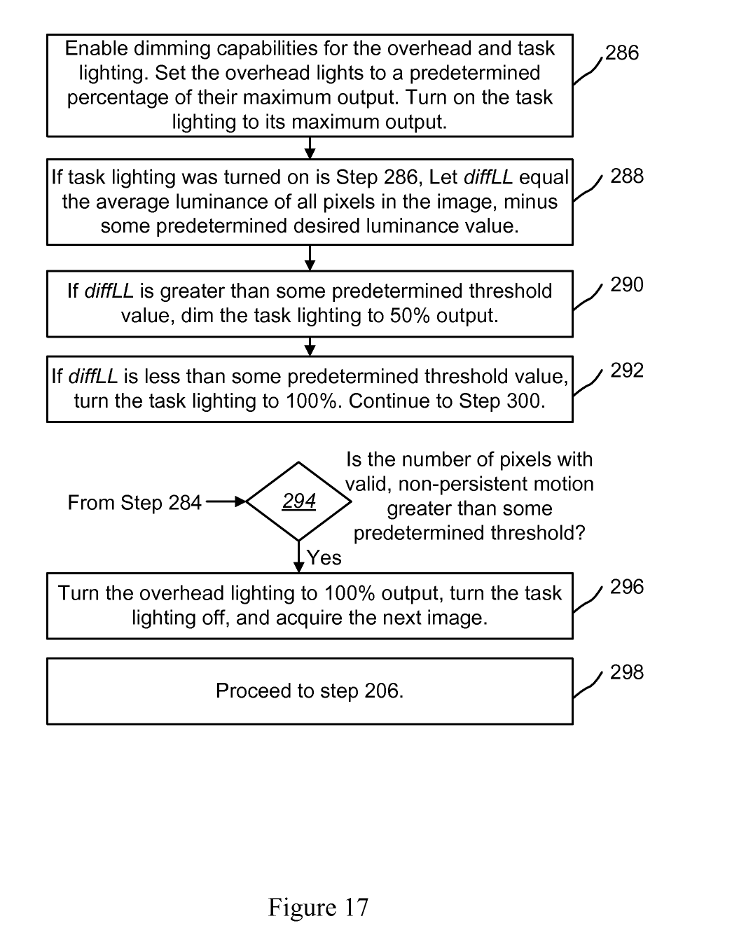

In step 284, if the Task Region 152 is not occupied, the process proceeds to step 294, illustrated in FIG. 17. If the Task Region 152 is occupied, the process proceeds to step 286, also shown in FIG. 17, where the dimming capabilities for the overhead and task lighting are enabled and the overhead lights are set to a predetermined percentage of their maximum output. The task lighting is also set to its maximum output in step 286.

In step 288, if task lighting was turned on in step 286, the variable diffLL equals the average luminance of all pixels in the image, minus some predetermine desired luminance value. In step 290, if diffLL is greater than some predetermine threshold value, the task lighting may be dimmed to 50% of the maximum value or some other predetermined value. In step 292, if diffLL is less than the predetermine threshold value, task lighting may be turned on to 100% and the process may continue to step 300.

Further step 294 may determine whether the number of pixels with valid, non-persistent motion is greater than some predetermined threshold. If so, the overhead lighting may be turned on to 100%, the task lighting may be turned off, and the next image may be acquired, as shown in step 296. After step 296, the process may repeat by proceeding back to step 206, as referred to in step 298.

### VII. Hardware

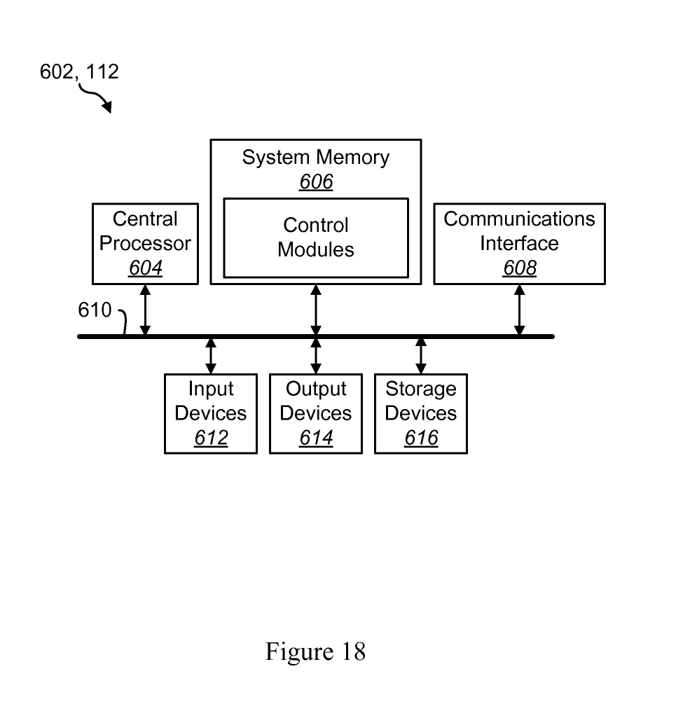

FIG. 18 depicts a block diagram of an electronic device 602 suitable for implementing the systems and methods described herein. The electronic device 602 may include, inter alia, a bus 610 that interconnects major subsystems of electronic device 602, such as a central processor 604, a system memory 606 (typically RAM, but which may also include ROM, flash RAM, or the like), a communications interface 608, input devices 612, output device 614, and storage devices 616 (hard disk, floppy disk, optical disk, etc.).

Bus 610 allows data communication between central processor 604 and system memory 606, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices.

For example, the controller 112 to implement the present systems and methods may be stored within the system memory 606. The controller 112 may be an example of the controller of FIGS. 1-3. Applications or algorithms resident with the electronic device 602 are generally stored on and accessed via a non-transitory computer readable medium (stored in the system memory 606, for example), such as a hard disk drive, an optical drive, a floppy disk unit, or other storage medium. Additionally, applications can be in the form of electronic signals modulated in accordance with the application and data communication technology when accessed via the communications interface 608

Communications interface 608 may provide a direct connection to a remote server or to the Internet via an internet service provider (ISP). Communications interface 608 may provide a direct connection to a remote server via a direct network link to the Internet via a POP (point of presence). Communications interface 608 may provide such connection using wireless techniques, including digital cellular telephone connection, Cellular Digital Packet Data (CDPD) connection, digital satellite data connection, or the like.

Many other devices or subsystems (not shown) may be connected in a similar manner. Conversely, all of the devices shown in FIG. 18 need not be present to practice the present systems and methods. The devices and subsystems can be interconnected in different ways from that shown in FIG. 18. The operation of an electronic device such as that shown in FIG. 18 is readily known in the art and is not discussed in detail in this application. Code to implement the present disclosure can be stored in a non-transitory computer-readable medium such as one or more of system memory 606 and the storage devices 616.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational or final functional aspect of the first signal.

While the foregoing disclosure sets forth various embodiments using specific block diagrams, flowcharts, and examples, each block diagram component, flowchart step, operation, or component described or illustrated herein may be implemented, individually or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described or illustrated herein are given by way of example only and can be varied as desired. For example, while the steps illustrated or described herein may be shown or discussed in a particular order, these steps do not necessarily need to be performed in the order illustrated or discussed. The various exemplary methods described or illustrated herein may also omit one or more of the steps described or illustrated herein or include additional steps in addition to those disclosed.

Furthermore, while various embodiments have been described or illustrated herein in the context of fully functional electronic devices, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in an electronic device. In some embodiments, these software modules may configure an electronic device to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

What is claimed is:

1. A computer-implemented method for monitoring and controlling a controlled space, the method comprising:
partitioning a controlled space into one or more regions;
evaluating motion within the controlled space;
determining occupancy within the one or more regions.

2. The method of claim 1, further comprising adjusting conditions within the controlled space based on whether non-persistent motion has occurred within the controlled space.

3. The method of claim 2, wherein adjusting conditions is selected from the group consisting of adjusting general lighting, adjusting task lighting, adjusting heating, adjusting ventilation, and adjusting cooling.

4. The method of claim 1, wherein determining occupancy comprises driving a state machine with a plurality of triggers corresponding to whether non-persistent motion has occurred within the controlled space.

5. The method of claim 4, wherein a trigger of the plurality of triggers is selected from the group consisting of a motion disappear trigger, a workspace motion trigger, an outer border region trigger, an inner border region trigger, and a failsafe timeout trigger.

6. The method of claim 4, wherein the state machine comprises one or more occupied states and one or more transition states.

7. The method of claim 6, wherein the transition states comprises a first transition state corresponding to the outer border trigger and a second transition state corresponding to the inner border trigger.

8. The method of claim 2, wherein adjusting conditions comprises adjusting task specific lighting corresponding to an interior region within the controlled space.

9. The method of claim 1, wherein evaluating comprises:
creating a difference image from two sequential images;
creating a corrected difference image from the difference image;
creating a persistence image from the corrected difference image; and
creating a history image from the persistence image.

10. The method of claim 9, wherein creating a persistence image comprises incrementing a persistence count if motion has occurred and decrementing the persistence count if motion has not occurred.

11. An system for monitoring and controlling a controlled space, comprising:
a sensor interface module configured to collect a sequence of images for a controlled space;
a partitioning module configured to partition out of the controlled space an inner border region, an outer border region, and one or more interior regions;
a motion evaluation module configured to evaluate from the sequence of images whether non-persistent motion has occurred within the inner border region, the outer border region and the one or more interior regions; and
an occupant determination module configured to use successive evaluations of whether non-persistent motion has occurred within the inner border region, the outer border region and the one or more interior regions to determine whether the controlled space is occupied.

12. The system of claim 11, wherein the occupant determination module comprises a state machine and a state machine update module configured to drive the state machine with a plurality of triggers corresponding to whether non-persistent motion has occurred within specific regions of the controlled space.

13. The system of claim 12, wherein a trigger of the plurality of triggers is selected from the group consisting of a motion disappear trigger, a workspace motion trigger, an outer border region trigger, an inner border region trigger, and a failsafe timeout trigger.

14. The system of claim 12, wherein the state machine comprises one or more occupied states and one or more transition states.

15. The system of claim 14, wherein the transition states comprises a first transition state corresponding to the outer border trigger and a second transition state corresponding to the inner border trigger.

16. The system of claim 11, further comprising a conditions control module for adjusting conditions within the controlled space based on an evaluation of whether non-persistent motion has occurred within the controlled space.

17. The system of claim 16, wherein the conditions control module is configured to make an adjustment selected from the group consisting of a general lighting adjustment, a task lighting adjustment, a heating adjustment, a ventilation adjustment, and a cooling adjustment.

18. The system of claim 11, wherein the motion evaluation module comprises:
a motion detection module configured to perform a comparison of a past and a current image and create a difference image;
a noise reduction module configured to create a corrected difference image from the difference image;
a motion persistence module configured to create a persistence image from the corrected difference image; and
a motion history module configured to create a motion history image from the persistence image.

19. The system of claim 18, wherein the motion persistence module is further configured to increment a persistence count if motion has occurred and decrement the persistence count if motion has not occurred.

20. A system for monitoring and controlling a controlled space, the system comprising:
a sensor configured to provide a sequence of images for a controlled space;
a controller configured to:
receive the sequence of images for the controlled space;
partition out of the controlled space an inner border region, an outer border region, and one or more interior regions;
evaluate from the sequence of images whether non-persistent motion has occurred within the inner border region, the outer border region, and the interior regions over the sequence of images;
use successive evaluations of whether non-persistent motion has occurred within the inner border region, the outer border region and the one or more interior regions to determine whether the controlled space is occupied; and
a controllable device selected from the group consisting of a lighting device, a heating device, a cooling device, and a ventilation device.
